(19) United States
(12) Patent Application Publication
(10) Pub. No.: US 2014/0222464 A1
(43) Pub. Date: Aug. 7, 2014

(54) System and Method Of Using Patient-Specific Data To Drive Patient-Specific Decisions

(71) Applicants: Paul Sharaf, Zionsville, IN (US); Mila Sharaf, Zionsville, IN (US)

(72) Inventors: Paul Sharaf, Zionsville, IN (US); Mila Sharaf, Zionsville, IN (US)

(21) Appl. No.: 14/170,630

(22) Filed: Feb. 2, 2014

Related U.S. Application Data
(60) Provisional application No. 61/759,554, filed on Feb. 1, 2013.

(51) Int. Cl. G06F 19/00

(52) U.S. Cl. CPC G06F 19/3481
USPC 705/3

(57) ABSTRACT

Provided is an electronic medical records system enhancement and method of implementation and use. The system is in electronic communication through a network with one or more databases containing patient-specific data identifying any or all medications for which a patient's pharmaceutical benefit provider provides financial benefits, and identifying the net cost to the patient of each medication in view of all financial benefits and restrictions that the pharmaceutical benefit provider provides to that particular patient. The patient's health savings and related accounts can be linked to the system and their preferred order of payment automated. A pharmacy may access certain patient-specific data though the system to quickly compare net costs to the patient for appropriate medication substitutes.

### CROSS-REFERENCE TO RELATED APPLICATIONS

The present application claims priority to and incorporates herein by reference U.S. Provisional Patent Application No. 61/759,554 to Sharaf et al., entitled System and Method Of Using Patient Level Data To Drive Patient-Level Decisions, filed Feb. 1, 2013.

### FEDERALLY SPONSORED RESEARCH OR DEVELOPMENT

None.

### TECHNICAL FIELD

The present invention relates generally to healthcare technology, and more specifically to electronic systems and methods for prescribing and providing medicine and the like to healthcare consumers.

### BACKGROUND

The current electronic prescribing transaction is wrought with inefficiencies and suboptimal customer experiences for physicians, pharmacists, patients, health insurance plans, and employers. There has long been a need to improve the experience, improve productivity for all parties, and improve medication adherence.

Physicians and their staff have imperfect information at the time of making a treatment decision for a patient. The emergence of myriad prescription benefit designs over the last several years has made it virtually impossible for a physician to know at the time of prescribing which medications will be covered by the patient's insurance, what restrictions may exist (prior authorization, step edit, or quantity limit), and what the patient's out-of-pocket cost will be when the claim is submitted for adjudication at the pharmacy. Even with the advent of electronic medical records, electronic prescribing, and electronic prescription formulary platforms, fundamental systemic problems persist. This is largely because the information provided to the physician at the time of prescribing medication is not patient-specific, is often incorrect, and fails to indicate the patient's actual out-of-pocket cost.

A typical example of a present electronic prescribing transaction and system 100 is depicted in FIG. 1. A patient 10 visits the office of their doctor or other healthcare provider (HCP) 20, and the HCP 20 determines that it is appropriate to write a prescription for medication for the patient 10. If the HCP 20 does not use an electronic medical record (EMR) platform or system 30 synchronized 32 with electronic data from a formulary aggregator 40, the HCP 20 may ask the patient 10 or refer to a paper chart (not shown) to identify what health plan the patient 10 has. The HCP 20 typically refers to the medical benefit provider 50 identified on the patient's 10 medical benefits card 12 (since the HCP 20 typically bills the medical benefit provider 50 for the HCP's services). But in doing so the HCP 20 may inadvertently be looking at the wrong plan for prescriptions. In the past, the patient's 10 medical benefit provider 50 was traditionally also the patient's 10 pharmacy benefit provider 90. But increasingly, the patient's 10 medical benefit provider 50 is a different entity than the patient's 10 pharmacy benefit provider 90, with different coverage. For instance, employer-sponsored, state-sponsored, federal-sponsored, and private exchange-offered benefits can all vary in terms of drug coverage, deductible, copay, coinsurance, and the like. Accordingly, the prescribing HCP's 20 perception of formulary coverage may be incorrectly based on inapplicable prescription coverage offered by the patient's 10 medical benefit provider 50 but not used by the patient 10. While FIG. 1 depicts the situation where the Formulary Aggregator(s) 40 are getting their information 55 from Medical Benefit Provider 50, it is understood that in other instances the Formulary Aggregator(s) 40 may get their information from Pharmaceutical Benefit Provider 90 (communication path not shown), or that Medical Benefit Provider 50 and Pharmaceutical Benefit Provider 90 may be the same entity with the same terms for various patients 10. Regardless, in any of these cases the information available at the formulary aggregators 40 is non-patient-specific general formulary information as opposed to patient-specific information.

The HCP 20 may have a general perception of formulary coverage based on what the HCP 20 understands to be the applicable prescription plan. The HCP might also reference an online formulary aggregator 40 (like FingertipFormulary.com), which provides general formulary information for providers 50, but does not provide patient-specific data. However, such general formulary information is frequently out-of-date and incorrect, because medical benefit providers 50 only occasionally provide updates 55 to formulary aggregators 40 (for instance annually or when coverage is changed). This inaccuracy problem may be further compounded when the HCP 20 does use an EMR platform 30 linked to aggregators 40, because such systems 30 only periodically synchronize 32 their electronic formulary data with the often out-of-date formulary aggregators 40. The foregoing steps are represented in FIG. 1 as the HCP 20 entering data 22 from the patient's 10 medical benefits card 12 into the EMR system 30, then the EMR system 30 responds with a list 34 of drugs approved by the (likely out-of-date) general formulary associated with that medical provider 50. The list 34 of drugs (referred to herein alternatively as medicines, pharmaceuticals, and similar terms) is usually limited to a simple yes indication for each approved drug, such as a green “thumbs-up” or “smiley face” symbol or other designation indicating formulary coverage. Present-day EMR platforms 30 of which the inventors are aware provide no patient-specific pharmaceutical cost or availability information to assist the HCP's drug selection 26. Based on this limited non-patient-specific information 34 that is culled from aggregated data for a provider 50, the HCP 20 makes a drug selection 26. The drug selection 26 is then communicated 36 to a pharmacy 60.

With continuing reference to FIG. 1, once the pharmacy 60 receives the drug selection 26, it engages in a separate “adjudication” process that may have little or no overlap with the information and systems used by the HCP 20 to make the drug selection 26. The patient 10 provides the pharmacy 60 with a pharmaceutical benefits card 14 that typically provides information such as Rx Bin, Group, and PCN numbers to aid the pharmacist in submitting a prescription for adjudication. For example, the pharmacy 60 may provide data 62 from the patient's 10 on-file pharmaceutical benefits card 14 to a transition switch hub system (TSH) 70, along with an adjudication request 64 for the selected drug. The TSH 70 may then process and communicate 72 the request information to a pharmacy benefits manager system (PBM) 80, which may further process and communicate 82 the request information to the pharmaceutical benefit provider 90. In this example system 100, the pharmaceutical benefit provider 90 performs a patient-specific analysis of the adjudication request 64 in view of the patient's 10 data 62, and determines whether the patient 10 is eligible under their specific pharmaceutical benefit plan for the selected drug, and the total or net financial obligation of the patient 10 for the selected drug, in view of the patient's 10 present coverage amounts, co-pays, deductibles, limits, and patient-specific policy information such as unique riders for benefits provided by a particular employer. This adjudication response information for the selected drug, including eligibility and financial obligation for the patient 10, may be communicated 92 from the pharmaceutical benefit provider 90 to the PBM 80, where it may be processed and further communicated 84 to the TSH 70, where it may be processed and further communicated 74 to the pharmacy 60. Note that some of the above steps may be optional in present adjudication systems, and present adjudication systems may include additional steps, such that in alternative example systems (not shown) the request information and/or the response information may not pass through or be processed by any of the TSH 70, PBM, 80, or pharmaceutical benefit provider 90, and/or may pass through and be processed by other systems. For example, the PBM 80 may perform the adjudication analysis on behalf of the pharmaceutical benefit provider 90.

At this point the patient 10 then proceeds to the pharmacy 60, which may be located several miles from the HCP 20 office, to pick up their medication prescribed by the HCP 20 at step 26. Unfortunately for the patient 10, all too frequently the present systems 100 result in the patient 10 arriving at the pharmacy 60 only to find out that the prescribed medication was either unavailable at the Pharmacy 60, “rejected” (not covered) by the patient's 10 plan with their pharmaceutical benefit provider 90, or the financial obligation of the patient 10 for the selected medication is dramatically different than what the prescribing HCP 20 had suggested. This occurs frequently in present systems 100 because the HCP's 20 reference to general formulary information 55, even for the correct provider 90, neither provides information regarding the availability of the drug, nor patient-specific information regarding one or more of the patient's 10 present coverage amounts, co-pays, deductibles, limits, and patient-specific policy information such as unique riders for benefits provided by a particular employer.

This tends to confuse and frustrate the patient 10, sometimes causing the patient 10 to abandon their efforts to obtain proper medication, resulting in no care for their medical condition/diagnosis. In present systems 100, a fax may then be sent to the HCP 20, often originating from a different location and staff than the pharmacy 60, informing the office of the HCP 20 that the drug selection 36 was rejected, often with no indication of any preferred, lower cost, or other alternative medication otherwise available to the patient 10 under their plan with their prescription benefits provider 90. The rejection may also be communicated from the pharmacy 60 to the office of the HCP 20 via an electronic prescription (eRx) system and put in an electronic queue at the office of the HCP 20 until office staff has time to clear the queue. In some cases personnel at the pharmacy 60 may attempt to call the office of the HCP 20 to request an alternative drug selection 36. The patient 10 and pharmacy 60 may wait hours for personnel at the HCP 20 to find the time to speak with the HCP 20 about another medication choice, or the HCP 20 may have left for the day and the patient 10 will have to return to the pharmacy 60 at another day or time.

When second and subsequent drug selections 36 are sent to the pharmacy 60, there is no guarantee that they will fare any better than the first rejected drug selection 36, in which case the process starts all over again until a medication finally gets approved or is affordable for the patient 10. Once a drug selection 36 is approved and processed by the pharmacy 60, the patient 10 may elect to satisfy all or part of the resulting financial obligation by applying funds from a health savings account, flexible spending account, health reimbursement account, or the like 16. This adds yet another layer of complexity to the electronic prescribing transaction before the patient's actual out-of-pocket expenses are finally determined, and renders essentially impossible the accurate estimation of the patient's out-of-pocket expenses for a given medicine at the drug selection stage 26.

For at least all the above reasons, there has long been a need to improve electronic prescribing transactions and systems.

### SUMMARY

The present invention elegantly addresses all the above challenges and provides numerous additional benefits. In various example embodiments the solution discovered by the present inventors may provide therapeutic and cost transparency for the prescriber, by linking the prescriber to the patient-specific data that was historically only accessible to the pharmacist. In various example embodiments the solution may expand patient-specific visibility to all treatment choices for a given diagnosis. By integrating the plan information for the patient and pushing it through to the EMR, the prescriber can access real-time cost-to-patient information based on account transactions. Concurrently, the prescriber may have full patient-specific formulary and restriction information across the treatment options for a given diagnosis instead of higher-level general information based on benefit design. By having both these types of information the prescriber can make decisions on what is available to that patient and have the patient's commitment for the drug therapy as well as affordability since actual cost is available upfront at the point of care. In this new and improved model, the choice for drug therapy is not reactive based on rejections or unexpected cost at the pharmacy. Various specially-adapted computer systems, servers, networks and related systems are provided to constitute systems and facilitate methods.

For example, provided in various example embodiments is an electronic prescribing system comprising: an electronic medical records system comprising one or more processor units, one or more programmable memory units, data storage medium, one or more input ports, one or more output ports, and circuitry connecting to a network, the electronic medical records system adapted to receive a first input from a prescriber at a location of a health care provider for a patient, said first input identifying the patient and a pharmaceutical benefit provider for the patient; one or more databases in electronic communication with the electronic medical records system through the network and containing patient-specific data identifying any or all medications for which the pharmaceutical benefit provider provides financial benefits for the patient, said data also identifying the net cost to the patient of each of said medications in view of all financial benefits that the pharmaceutical benefit provider provides to the patient for each of said medications at a current time; and a pharmacy in electronic communication with the electronic medical records system through the network; the electronic medical records system adapted to electronically access and process said data and communicate to the prescriber the identities of any or all of said medications and their net costs to the patient upon receiving an electronic information request from the prescriber; the electronic medical records system adapted to receive a second input from the prescriber comprising a prescription for the patient for one or more of said medications, the electronic medical records system further adapted to electronically communicate said prescription to the pharmacy.

It is noted that in various example embodiments the pharmaceutical benefit provider may be a/the medical benefits provider, in which case the terms are synonymous.

Various example embodiments may further comprise the electronic medical records system in electronic communication with one or more financial accounts of the patient's, the electronic medical records system adapted to electronically access said one or more financial accounts upon the patient's request and communicate to the prescriber financial information provided by said one or more financial accounts. Various example embodiments may further comprise the one or more financial accounts of the patient's selected from a group consisting of one or more of: a health savings account, a flexible spending account, a health reimbursement account.

Various example embodiments may further comprise the electronic medical records system in electronic communication with one or more financial accounts of the patient's, the electronic medical records system adapted to electronically bill the one or more financial accounts in a predetermined order of preference preselected by the patient. Various example embodiments may further comprise the one or more financial accounts of the patient's selected from a group consisting of one or more of: a health savings account, a flexible spending account, a health reimbursement account, a credit card account, a debit card account, an online payment account, a bank account.

Various example embodiments may further comprise the electronic medical records system adapted to receive a patient diagnosis input (which may constitute identification or selection of a therapeutic class), process the patient diagnosis input, generate a list of possible treatments for the patient based on the patient diagnosis input, and communicate to the prescriber the list of possible treatments. Various example embodiments may further comprise the electronic medical records system adapted to allow the prescriber to generate the electronic information request by selecting from the list of possible treatments. Various example embodiments may further comprise the electronic medical records system adapted to allow the prescriber to generate the prescription by selecting from the list of possible treatments.

Various example embodiments may further comprise the electronic medical records system adapted to communicate to the pharmacy the identities of any or all of said medications and their net costs to the patient upon receiving an electronic information request from the pharmacy.

Various example embodiments may further comprise the first input selected from the group consisting of: electronic data from a database; an electronic signal from a keyboard; an electronic signal from a mouse; an electronic signal from a computer peripheral device; an electronic signal from a touch screen device; an electronic signal from a scanner; an electronic signal from a card reader. Various example embodiments may further comprise the electronic information request selected from the group consisting of: an electronic signal from a keyboard; an electronic signal from a mouse; an electronic signal from a computer peripheral device; an electronic signal from a touch screen device; an electronic signal from a scanner. Various example embodiments may further comprise the second input selected from the group consisting of: an electronic signal from a keyboard; an electronic signal from a mouse; an electronic signal from a computer peripheral device; an electronic signal from a touch screen device; an electronic signal from a scanner. Various example embodiments may further comprise the electronic medical records system adapted to communicate to the prescriber the identities of any or all of said medications and their net costs to the patient by means selected from the group consisting of: email; fax; printed document; electronic display.

Various example embodiments may further comprise the one or more databases in electronic communication with the electronic medical records system via the Internet. Various example embodiments may further comprise the pharmacy in electronic communication with the electronic medical records system via the Internet. Various example embodiments may further comprise the one or more financial accounts of the patient's in electronic communication with the electronic medical records system via the Internet.

Also provided in various example embodiments is a method of electronically prescribing a medication for a patient, comprising the steps of: at a location of a health care provider for a patient, inputting into an electronic medical records system a first input identifying the patient and a pharmaceutical benefit provider for the patient; causing the electronic medical records system to electronically access one or more databases and retrieve therefrom and provide to a prescriber at the location of the health care provider any or all of certain information relating specifically to the patient, said information identifying any or all medications for which the pharmaceutical benefit provider provides financial benefits for the patient, said information further identifying the net cost to the patient of each of said medications in view of all financial benefits that the pharmaceutical benefit provider provides to the patient for each of said medications at a current time; at the location of the health care provider, inputting into the electronic medical records system a second input comprising a prescription for the patient for one or more of said medications; and causing the electronic medical records system to electronically communicate said prescription to a pharmacy.

Various example embodiments may further comprise the steps of: causing the electronic medical records system to electronically communicate with one or more financial accounts of the patient's; and causing the electronic medical records system to electronically bill said one or more financial accounts automatically in a predetermined order of preference.

Various example embodiments may further comprise the steps of: inputting a patient diagnosis into the electronic medical records system; receiving from the electronic medical records system a list of possible treatments for the patient, based on the patient diagnosis; and wherein the step of inputting a second input comprises selecting one or more medications from the list of possible treatments.

Also provided in various example embodiments is a method of modifying an electronic prescribing system, the electronic prescribing system comprising: an electronic medical records system comprising one or more processor units, one or more programmable memory units, data storage medium, one or more input ports, one or more output ports, and circuitry connecting to a network; the method comprising the steps of: reprogramming one or more of the programmable memory units to cause one or more of the processor units to change the content of and redirect from a first destination to a second destination certain electronic communications sent from the electronic medical records system through the network; wherein the content of said certain electronic communications is changed from a request for non-patient-specific formulary information for a benefit provider to a request for patient-specific benefit information regarding medications for which a pharmaceutical benefit provider provides financial benefits for a specific patient; and wherein the first destination comprises one or more first databases in electronic communication with the network, the one or more first databases containing first benefit data that is at least primarily non-patient-specific, and the second destination comprises one or more second databases in electronic communication with the network, the one or more second databases containing second benefit data that is at least primarily patient-specific.

The invention is preliminarily shown and described in the accompanying written description and figures, which incorporates various technical information by reference. Additional aspects, alternatives and variations as would be apparent to persons of skill in the art are also disclosed herein and are specifically contemplated as included as part of the invention. The invention is set forth only in the claims as allowed by the patent office in this or related applications, and the following descriptions of certain example embodiments are not in any way to limit, define or otherwise establish the scope of legal protection.

### BRIEF DESCRIPTION OF THE DRAWINGS

The accompanying figures illustrate certain aspects of example embodiments of the invention.

FIG. 1 is a diagram depicting an example system, data flow, and adjudication in the current state as described in the Background.

FIG. 2 is a diagram depicting example aspects of example embodiments of the system and method of the present invention.

FIG. 3A is a diagram depicting example aspects of example embodiments of the system and method of the present invention.

FIG. 3B is a diagram depicting example aspects of example embodiments of the system and method of the present invention.

FIG. 3C is a diagram depicting example aspects of example embodiments of the system and method of the present invention.

### DETAILED DESCRIPTION OF EXAMPLE EMBODIMENTS

Reference will now be made in detail to some specific examples of the invention, including any best mode contemplated by the inventor for carrying out the invention. Examples of these specific embodiments are illustrated in the accompanying drawings. While the invention is described in conjunction with these specific embodiments, it will be understood that it is not intended to limit the invention to the described or illustrated embodiments. On the contrary, it is intended to cover alternatives, modifications, and equivalents as may be included within the spirit and scope of the invention as defined by the appended claims.

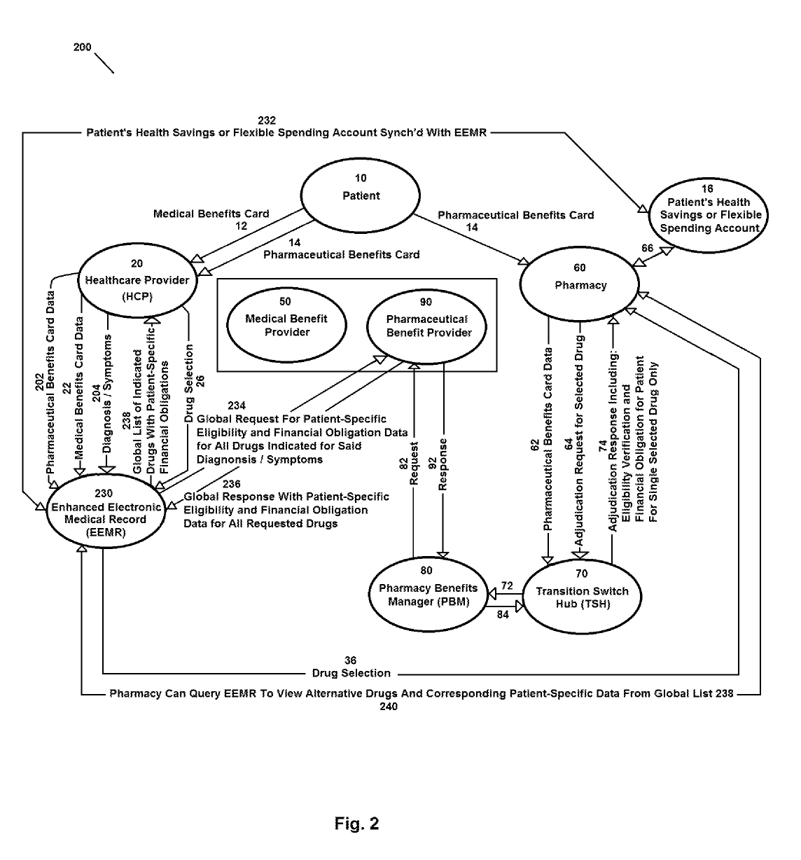

In the following description, numerous specific details are set forth in order to provide a thorough understanding of the present invention. Particular example embodiments of the present invention may be implemented without some or all of these specific details. In other instances, process operations well known to persons of skill in the art have not been described in detail in order not to obscure unnecessarily the present invention. For instance, while FIG. 2 shows EEMR 230 in data communication with Pharmaceutical Benefit Provider 90 to emphasize that feature, it is understood that EEMR 230 would also in various example embodiments be in data communication with Medical Benefit Provider 50, since the HCP 20 typically bills a patient's Medical Benefit Provider 50 for HCP's medical services provided to the patient 10.

Various techniques and mechanisms of the present invention will sometimes be described in singular form for clarity. However, it should be noted that some embodiments include multiple iterations of a technique or multiple mechanisms unless noted otherwise. For example, a system may utilize a network. However, it will be appreciated that a system can use multiple networks while remaining within the scope of the present invention unless otherwise noted.

Similarly, various steps of the methods shown and described herein are not necessarily performed in the order indicated, or performed at all in certain embodiments. Accordingly, some implementations of the methods discussed herein may include more or fewer steps than those shown or described.

Further, the techniques and mechanisms of the present invention will sometimes describe a connection, relationship or communication between two or more entities. It should be noted that a connection or relationship between entities does not necessarily mean a direct, unimpeded connection, as a variety of other entities or processes may reside or occur between any two entities. For example, several entities are described as connected by, or communicating through, various networks, but it will be appreciated that a variety of computer networks, phone lines, satellite communications, wireless networks and the like may exist between the entities shown. Consequently, an indicated connection does not necessarily mean a direct, unimpeded connection unless otherwise noted. For instance, the terms “communicating with,” “in electronic communication with,” and the like mean being in data communication with, regardless of intervening devices or processing.

The term electronic medical record (EMR) is to be interpreted herein broadly and encompass and/or be equivalent to terms such as electronic patient record (EPR) and electronic health record (EHR). The term “medication” is used broadly as a substance used for medical treatment, such as a medicine or drug. The term “pharmaceutical” is likewise used herein broadly and synonymously with the term medication. As used herein including in the Figures, the term “drug” is meant to be broader than a technical definition of that term, and is intended to encompass all medications, whether or not they are technically considered drugs.

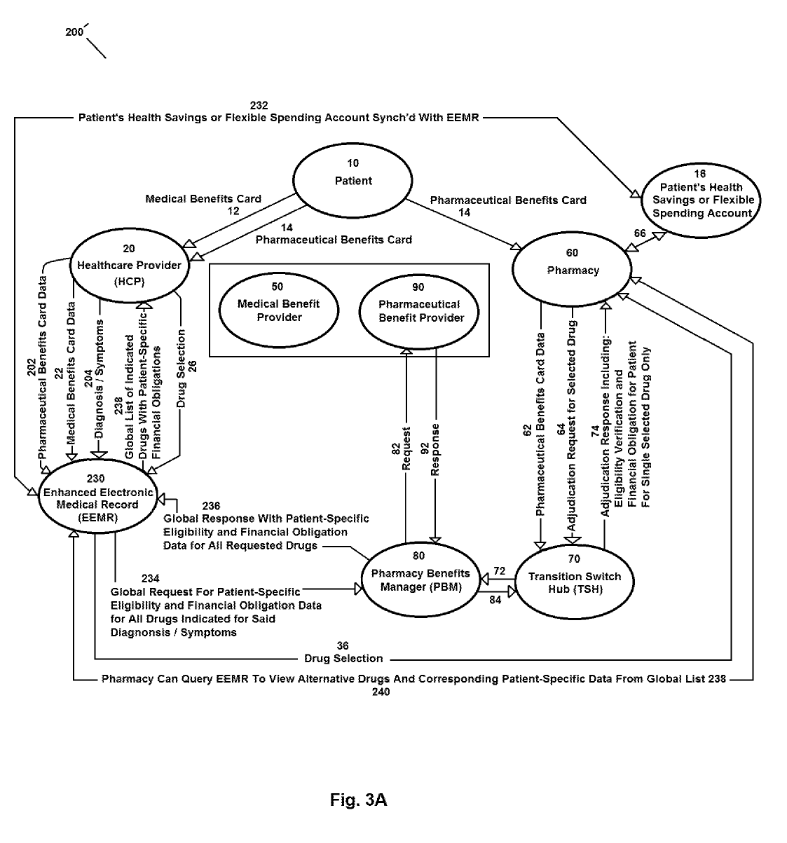

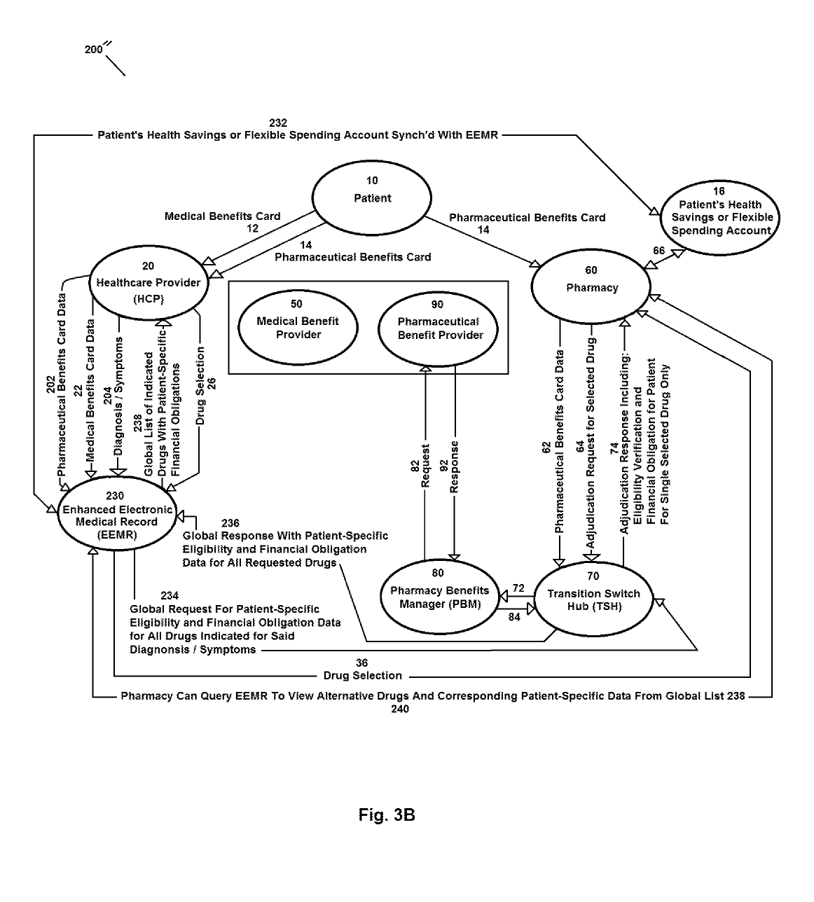

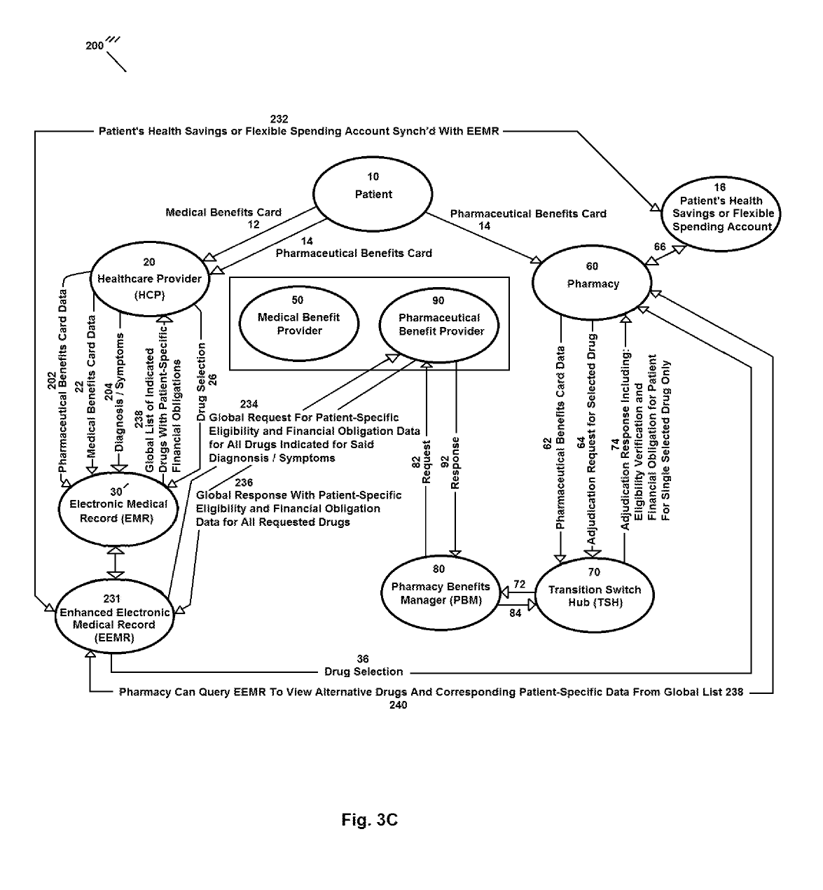

In various example embodiments the solution discovered by the present inventors is adapted to provide therapeutic and cost transparency for the prescriber, by linking the prescriber with patient-specific data that historically was only accessible to the pharmacist. For example, the prescriber may be provided with patient-specific formulary and restriction information instead of higher-level non-patient-specific information based on benefit design. By accessing and integrating the pharmaceutical benefit plan information specific to the individual patient and pushing it through to the health care provider's electronic medical record system, the prescriber can simultaneously access real-time net cost-to-patient information for various medications. By having patient-specific information the prescriber can make better decisions regarding the patient's options and obtain the patient's commitment for the medication/drug therapy in view of its affordability, since actual cost will be available upfront at the point of care. In these models, the choice for drug therapy is not reactive based on rejections or unexpected cost at the pharmacy, which streamlines the process and provides numerous benefits as will be apparent to persons of skill in the art. Example aspects of various example embodiments will now be described with reference to FIGS. 2, 3A, 3B, and 3C.

Patient 10 checks-in at the reception window of the office of the HCP 20, and provides or has previously provided their medical benefits information or card 12 and, if separate, their pharmaceutical benefits information or card 14. Personnel at the office of the HCP 20 swipes (or scans or manually enters) the card(s) 12, 14 or their data at which time the patient's 10 medical history, labs, prescription history from any care provider, plus pharmacy preferences (retail vs. mail, location, etc.) are made available to the HCP 20 by the enhanced electronic medical record system (EEMR) 230. It is noted that while the first input may be a manual input of a patient's pharmaceutical benefits card 14 or data, it may alternatively be any other suitable input, such as a patient's medical benefits card 12 or other patient-identifying indicia that is electronically linked or associated within the system (for instance on a server within or connected with the EEMR 230) to the patient's pharmaceutical benefits information.

Prior to the visit, the patient 10 may also have opted to link their health card(s) data 12, 14 with one or more accounts, such as a flexible a health savings account (HSA), a flexible spending account (FSA), a health reimbursement account (HRA), a credit card account, a debit card account, an online payment account such as, for example, a PayPal™ account, or any type of bank account (hereafter collectively “patient's accounts” 16), so that patient's accounts 16 may be charged any co-pay required of patient 10. The patient 10 may also in various example embodiments be provided with access to the EEMR 230, for instance via an online log-in on the Internet, for purposes of linking patient's accounts 16 with patient's medical record in EEMR 230. In various of those embodiments, patient 10 may enter into the EEMR 230 an order of preference for the EEMR's billing of patient's accounts 16. For example, the patient 10 may interact with a graphical user interface (GUI) generated by the EEMR 230 on the Internet to instruct the EEMR 230 to satisfy invoices issued by the EEMR 230 by billing a first account up to an amount or limit, then a second account up to an amount or limit, etc., any of which may be based on available balances in any of patient's accounts 16. Alternatively, personnel at the office of the HCP 20 or others may provide or enter these types of instructions to the EEMR 230 at the direction of the patient 10. Subsequently, each time the HCP 20 issues an invoice to a patient 10, for instance for a co-pay for a medical visit, the EEMR 230 may execute the above instructions and satisfy payment automatically, with the patient's consent, by deducting payment from patient's accounts 16 in the order and manner that the EEMR 230 was previously instructed by or on behalf of patient 10.

When the patient 10 is seen by the HCP 20 and a treatment is being considered, the covered medications by therapeutic class would be available in the EEMR system 230 with the exact patient-specific out-of-pocket cost details and any restrictions that are required at the patient-specific level. The HCP 20 can have a conversation with the patient 10 about treatment options and costs and they can make an informed choice based on effectiveness, safety, side effects, and for the first time ever of which the inventors are aware, exact net cost to the patient 10. For example, if the patient 10 has an HRA/HSA/FSA balance or other account 16 to cover any “patient responsibility” portion of a treatment option, the HCP 20 and patient 10 will be able review information provided by the EEMR 230 to differentiate between the “patient responsibility” (i.e., patient-specific co-pay information provided by the patient's pharmaceutical benefit provider 90) and the actual net payment that the patient 10 will have to pay out-of-pocket (i.e., the amount that will need to be paid to the pharmacy 60 directly from the patient 10 via cash, check, or debit/credit card, after payments are made from patient's accounts 16). This will provide a clear understanding of affordability while the patient 10 is still in the office of the HCP 20.

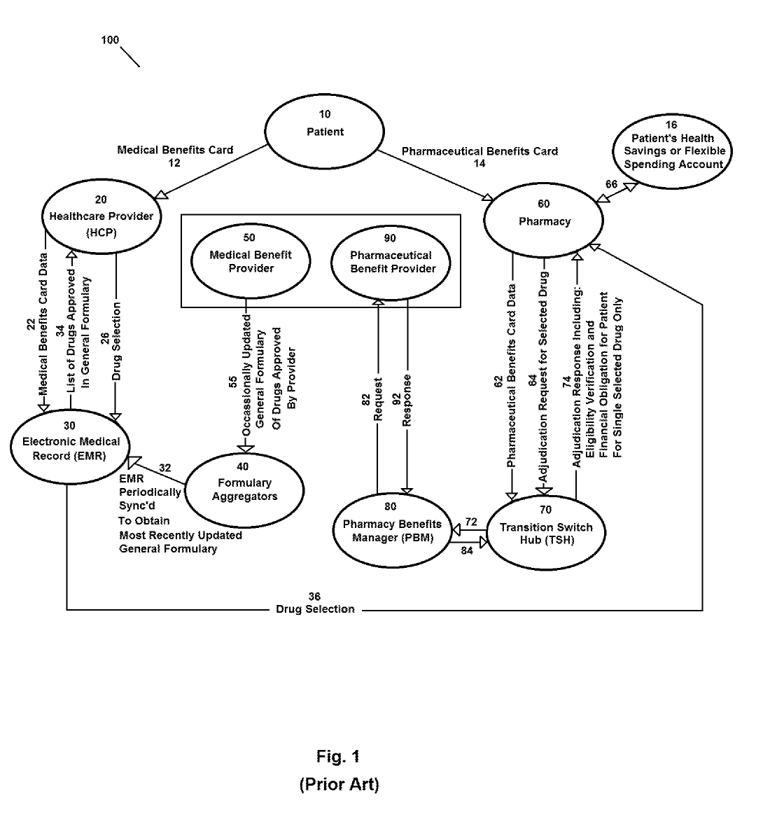

Once one or more medications have been decided upon, the HCP 20 in various example embodiments may confirm whether the patient 10 wants the prescription sent to their home via mail-order pharmacy or picked up at the pharmacy of their choice (collectively, pharmacy 60), and enter that information into the EEMR 230. If mail order is selected, the HCP 20 may choose to provide samples to cover the time until the mail order prescription is delivered. A prescriber, typically an HCP 20 or person at the office of the HCP 20, then enters the prescription into the EEMR 230 and causes the EEMR 230 to transmit the prescription to the pharmacy 60. The pharmacy 60 may then take its normal course of action 62, 64, 72, 82, 92, 84, 74, as described in the Background with respect to FIG. 1. The patient 10 or someone acting on their behalf then typically travels to the pharmacy 60 and pays for and obtains the prescribed medication, paying the net out-of-pocket cost to the pharmacy 60 previously determined and communicated by EEMR 230, and causing patient's accounts 16 to pay certain amounts, for instance but not necessarily based on the balances and rules of those accounts 16 as previously provided by the EEMR 230 at the office of the HCP 20. The confusion, frustration, and wastes of time endemic to present system 100 are entirely avoided.

In certain example embodiments and where permitted by law, the prescription can be submitted for approval/adjudication through the EEMR 230, approved, and the process of charging the pharmacy co-pay to the patient's accounts 16 initiated by the EEMR 230 before the patient 10 leaves the office of the HCP 20. In these example embodiments the pharmacy 60 can perform its traditional task of reviewing and approving the appropriateness of the prescription before dispensing the medication to the patient 10, and the pharmacy 60 receives its payment in full or part from patient's accounts 16 as directed by EEMR 230.

An example electronic prescribing transaction and system 200 is depicted in FIG. 2. A patient 10 visits the office of their doctor or other healthcare provider HCP 20 and provides or has previously provided their medical benefits information or card 12 and, if separate, their pharmaceutical benefits information or card 14 or other patient-identifying indicia that is electronically linked or associated within the system (for instance on a server within or connected with the EEMR 230) to the patient's pharmaceutical benefits information. Personnel at the office of the HCP 20 inputs into the enhanced electronic medical record system EEMR 230 the patient's pharmaceutical benefits card data 202 and medical benefits card data 22 (which may be on the same card), for instance by swiping card(s) 12, 14 or accessing information on a database, at which time the patient's 10 medical history, labs, prescription history from any care provider, plus pharmacy preferences (retail vs. mail, location, etc.) are made available to the HCP 20 by the enhanced electronic medical record system EEMR 230.

For example, an EEMR system 230 may comprise one or more processor units, one or more programmable memory units, data storage medium, one or more input ports, one or more output ports, and circuitry connecting to a network, which network may comprise one or more networks, each of which may comprise the Internet, a local area network (LAN), a wide area network (WAN), or any other electronic network capable of communicating digital data. Examples of suitable hardware is known in the art and for succinctness is not reproduced herein. Examples of suitable hardware, software, systems, and other technologies that may be employed herein as will be apparent to persons of skill in the art are disclosed in, for example, the following United States patents and published patent applications, all of which are incorporated herein by reference as if reproduced herein in their entireties: U.S. Pat. No. 8,321,283 B2; US20120211561 A1; U.S. Pat. No. 6,834,271 B1; US20070067186 A1; US20120278228 A1; US20080183492 A1; U.S. Pat. No. 8,296,164 B2; US20010037216 A1; U.S. Pat. No. 8,065,165 B2; U.S. Pat. No. 7,174,302 B2; U.S. Pat. No. 7,426,474 B2; US20120290328 A1; U.S. Pat. No. 8,090,590 B2; US20120253842 A1; US20090319311 A1; US20050288972 A1; U.S. Pat. No. 5,924,074 A; US20120215560 A1; US20140025870 A1.

The EEMR 230 may be adapted to receive a first input 202 from a prescriber at a location of a health care provider 20 for a patient 10, said first input 202 identifying the patient 10 and a pharmaceutical benefit provider 90 for the patient 10; one or more databases in electronic communication with the EEMR 230 through the network and containing patient-specific data identifying any or all medications for which the pharmaceutical benefit provider 90 provides financial benefits for the patient 10 (or all medications relevant to a diagnosis or therapeutic category), said data also identifying the net cost to the patient 10 of each of said medications in view of all financial benefits that the pharmaceutical benefit provider 90 provides to the patient 10 for each of said medications at a current time, e.g., the time when queried by the EEMR 230. For example, the EEMR 230 may be adapted to electronically access and process said data, for instance by making a global request 234 to the pharmaceutical benefit provider (PBP) 90 for patient-specific eligibility and financial obligation data for all drugs (medications) identified by the HCP 20 or indicated for a given diagnosis or symptoms, and then receiving a global response 236 from the PBP 90 with patient-specific eligibility and financial obligation data for all requested drugs (medications). Alternatively as shown in FIGS. 3A and 3B, respectively, in systems 200′ and 200″, EEMR 230 might not communicate directly with PBP 90, but rather with PBM 80 or TSH 70, or any other suitable intermediaries capable of providing the desired patient-specific information.

Upon receiving an electronic information request from the prescriber, the EEMR 230 may be adapted to communicate to the prescriber at the location of the HCP 20 a global list 238 of indicated drugs (medications) with corresponding patient-specific net financial obligations associated with each, based on the data obtained from global response 236. The EEMR 230 may be adapted to receive a second input 26 from the prescriber comprising a prescription or drug (medication) selection for the patient 10 for one or more of said medications identified in said global list 238 of indicated drugs (medications). The EEMR 230 may be further adapted to electronically communicate said prescription 36 to a pharmacy 60 in electronic communication with the EEMR 230 through the network.

Various example embodiments may further comprise the EEMR 230 in electronic communication with one or more financial accounts 16 of the patient 10, the EEMR 230 being adapted to electronically access said one or more financial accounts 16 upon the patient's request and communicate to the prescriber (for instance through the EEMR 230) financial information provided by said one or more financial accounts 16. Various example embodiments may further comprise the EEMR 230 adapted to electronically bill the one or more financial accounts 16 in a predetermined order of preference preselected by the patient 10. The one or more financial accounts 16 may include a health savings account, a flexible spending account, a health reimbursement account, a credit card account, a debit card account, an online payment account (such as, for example, a PayPal™ account), a bank account, or any other suitable type of account.

Various example embodiments may further comprise the EEMR 230 adapted to receive a patient diagnosis input 204 (which may constitute identification or selection of a therapeutic class), process the patient diagnosis input 204, generate a list of possible treatments 238 for the patient based at least in part on the patient diagnosis input 204, which may have triggered request 234 and response 236, and communicate to the prescriber the list 238 of possible treatments. Various example embodiments may further comprise the EEMR 230 adapted to allow the prescriber to generate the electronic information request 204 by selecting from a previously stored data 236 listing possible treatments. Various example embodiments may further comprise the EEMR 230 adapted to allow the prescriber to generate the prescription 26 by selecting from the list 238 of possible treatments, and to communicate the prescription 36 to the pharmacy 60.

Various example embodiments may further comprise the EEMR 230 adapted to communicate to the pharmacy 60 the identities of any or all of said medications 238 and their net costs to the patient 10 upon receiving an electronic information request 240 from the pharmacy 60. This can be useful for example when the pharmacy 60 finds a conflict or problem with the medication ordered in the prescription 36; the pharmacy 60 can consult the previously-processed list 238 and recommend the next best choice in view of the previously-calculated patient-specific net cost data for all the medications in the list 238. In the past, the pharmacy 60 would have had to determine a list of alternative medications and send each alternative medication for adjudication before the net cost to the patient would be known or call and/or fax the office of the HCP 20 for another selection that would then need to be adjudicated, leading to a time-consuming, serial, hit-or-miss process and resulting decision based on incomplete information.

Various example embodiments may further comprise the first input 22 comprising any or all of electronic data from a database; an electronic signal from a keyboard; an electronic signal from a mouse; an electronic signal from a computer peripheral device; an electronic signal from a touch screen device; an electronic signal from a scanner; an electronic signal from a card reader; or any other suitable input 22 (such as an electronic signal from biometric scanners/identifiers). Various example embodiments may further comprise the electronic information request 204 comprising any or all of an electronic signal from a keyboard; an electronic signal from a mouse; an electronic signal from a computer peripheral device; an electronic signal from a touch screen device; an electronic signal from a scanner; or any other suitable signal 204 (such as an electronic signal from voice recognition software). Various example embodiments may further comprise the second input 26 comprising any or all of an electronic signal from a keyboard; an electronic signal from a keyboard; an electronic signal from a mouse; an electronic signal from a computer peripheral device; an electronic signal from a touch screen device; an electronic signal from a scanner; or any other suitable input 26 (such as an electronic signal from voice recognition software). Various example embodiments may further comprise the EEMR 230 adapted to communicate to the prescriber the identities of any or all of said medications and their net costs 238 to the patient 10 by any suitable means, such as email; fax; printed document; or electronic display on or by any electronic device, such as a computer screen or handheld/mobile device screen.

Various example embodiments may further comprise the one or more databases at or associated with PBP 90 in electronic communication with the EEMR 230 via the Internet. Various example embodiments may further comprise the pharmacy 60 in electronic communication with the EEMR 230 via the Internet. Various example embodiments may further comprise the one or more financial accounts 16 of the patient 10 in electronic communication with the EEMR 230 via the Internet. Additionally, the EEMR 230 or parts thereof may be located remotely from the HCP 20, such that the prescriber and/or HCP 20 (which may or may not be the same person(s)), may communicate with the EEMR 230 via the Internet. Further, various components and/or modules constituting the EEMR 230 may themselves be located remotely from each other, for instance on the “cloud” as that term is understood in the art of computing, in which case various components and/or modules constituting the EEMR 230 may communicate with each other via the Internet.

Also provided in various example embodiments is a method of electronically prescribing a medication for a patient 10, comprising the steps of: at a location of a health care provider 20 for a patient 10, inputting into an EEMR 230 a first input 22 identifying the patient 10 and a PBP 90 for the patient 10; causing the EEMR 230 to electronically access 234 one or more databases, which may located at or associated with PBP 90, and retrieve 236 therefrom and provide to a prescriber at the location of the health care provider 20 any or all of certain information 238 relating specifically to the patient 10, said information 238 identifying any or all medications for which the pharmaceutical benefit provider 90 provides financial benefits for the patient 10, said information 238 further identifying the net cost to the patient 10 of each of said medications in view of all financial benefits that the pharmaceutical benefit provider provides to the patient 10 for each of said medications at a current time; at the location of the health care provider 20, inputting into the EEMR 230 a second input 26 comprising a prescription for the patient 10 for one or more of said medications; and causing the EEMR 230 to electronically communicate 36 said prescription to a pharmacy 60.

Various example embodiments may further comprise the steps of: causing the EEMR 230 to electronically communicate with one or more financial accounts 16 of the patient 10; and causing the EEMR 230 to electronically bill said one or more financial accounts 16 automatically in a predetermined order of preference.

Various example embodiments may further comprise the steps of: inputting a patient diagnosis 204 into the EEMR 230; receiving from the EEMR 230 a list 238 of possible treatments for the patient 10 based on the patient diagnosis 204; and wherein the step of inputting a second input 26 comprises selecting one or more medications from the list 238 of possible treatments.

Also provided in various example embodiments is a method of modifying an electronic prescribing system 100 to become at least in part an enhanced electronic prescribing system 200, the initial electronic prescribing system 100 comprising: an electronic medical records system 30 comprising one or more processor units, one or more programmable memory units, data storage medium, one or more input ports, one or more output ports, and circuitry connecting to a network; the method comprising the steps of: reprogramming one or more of the programmable memory units to cause one or more of the processor units to change the content of and redirect from a first destination 40 to a second destination 90 certain electronic communications 32 sent from the electronic medical records system 30 through the network; wherein the content of said certain electronic communications is changed from a request 32 for non-patient-specific formulary information for a benefit provider to a request 234 for patient-specific benefit information regarding medications for which a pharmaceutical benefit provider 90 provides financial benefits for a specific patient 10; and wherein the first destination 40 comprises one or more first databases in electronic communication with the network, the one or more first databases containing first benefit data that is at least primarily non-patient-specific (such as, for example, general formularies associated with various benefit providers), and the second destination 90 comprises one or more second databases in electronic communication with the network, the one or more second databases containing second benefit data that is at least primarily patient-specific (such as, for example, a list of medications approved for a specific patient 10 and information regarding financial benefits that the pharmaceutical benefit provider 90 provides to the patient 10 for each of said medications at a current time).

In various example embodiments the above method may be accomplished by adding a new software module to the EMR 30. Alternatively, the above method may be accomplished by providing one or more separate servers that may be remotely located from but in communication with EMR 30, which the EMR 30 communicates with and which either act as an intermediary between EMR 30 and HCP 20 and/or PBP 90, or which otherwise cause the stated changes in the actions of EMR 30. For example as shown in system 200′″ in FIG. 3C, with respect to any or all of the embodiments discussed herein, the EEMR 230 may comprise a standard or modified EMR 30′ in electronic communication with a separate and/or remotely located EEMR 231, which may or may not provide any of the functionalities of a typical EMR 30 except EEMR 231 may enhance the functionality of EMR 30′ to effectively act as EEMR 230 as described herein, and the combination of EMR 30′ with EEMR 231 is considered and referred to synonymously as EEMR 230 unless otherwise stated. Further, EEMR 231 may be distributed across one or more networks and may reside on the cloud or one or more specific servers. EEMR 231 may communicate with any or all of PBP 90 (or PBM 80 or TSH 70 as indicated in FIGS. 3A and 3B), pharmacy 60 and patient accounts 16 as shown in FIG. 3C, or alternatively EEMR 231 may enable EMR 30′ to do so.

Any of the suitable technologies set forth and incorporated herein may be used to implement various example aspects of the invention as would be apparent to one of skill in the art.

Although exemplary embodiments and applications of the invention have been described herein including as described above and shown in the included example Figures, there is no intention that the invention be limited to these exemplary embodiments and applications or to the manner in which the exemplary embodiments and applications operate or are described herein. Indeed, many variations and modifications to the exemplary embodiments are possible as would be apparent to a person of ordinary skill in the art. The invention may include any device, structure, method, or functionality, as long as the resulting device, system or method falls within the scope of one of the claims that are allowed by the patent office based on this or any related patent application.

What is claimed is:

1. An electronic prescribing system comprising:
an electronic medical records system comprising one or more processor units, one or more programmable memory units, data storage medium, one or more input ports, one or more output ports, and circuitry connecting to a network, the electronic medical records system adapted to receive a first input from a prescriber at a location of a health care provider for a patient, said first input identifying the patient and a pharmaceutical benefit provider for the patient;
one or more databases in electronic communication with the electronic medical records system through the network and containing patient-specific data identifying any or all medications for which the pharmaceutical benefit provider provides financial benefits for the patient, said data also identifying the net cost to the patient of each of said medications in view of all financial benefits that the pharmaceutical benefit provider provides to the patient for each of said medications at a current time; and
a pharmacy in electronic communication with the electronic medical records system through the network;
the electronic medical records system adapted to electronically access and process said data and communicate to the prescriber the identities of any or all of said medications and their net costs to the patient upon receiving an electronic information request from the prescriber;
the electronic medical records system adapted to receive a second input from the prescriber comprising a prescription for the patient for one or more of said medications, the electronic medical records system further adapted to electronically communicate said prescription to the pharmacy.

2. The electronic prescribing system of claim 1, further comprising:
the electronic medical records system in electronic communication with one or more financial accounts of the patient's, the electronic medical records system adapted to electronically access said one or more financial accounts upon the patient's request and communicate to the prescriber financial information provided by said one or more financial accounts.

3. The electronic prescribing system of claim 2, further comprising:
the one or more financial accounts of the patient's selected from a group consisting of one or more of: a health savings account, a flexible spending account, a health reimbursement account, a credit card account, a debit card account, an online payment account, a bank account.

4. The electronic prescribing system of claim 1 further comprising:
the electronic medical records system in electronic communication with one or more financial accounts of the patient's, the electronic medical records system adapted to electronically bill the one or more financial accounts in a predetermined order of preference preselected by the patient.

5. The electronic prescribing system of claim 4, further comprising:
the one or more financial accounts of the patient's selected from a group consisting of one or more of: a health savings account, a flexible spending account, a health reimbursement account, a credit card account, a debit card account, an online payment account, a bank account.

6. The electronic prescribing system of claim 1, further comprising:
the electronic medical records system adapted to receive a patient diagnosis input, process the patient diagnosis input, generate a list of possible treatments for the patient based on the patient diagnosis input, and communicate to the prescriber the list of possible treatments.

7. The electronic prescribing system of claim 6, further comprising:
the electronic medical records system adapted to allow the prescriber to generate the electronic information request by selecting from the list of possible treatments.

8. The electronic prescribing system of claim 6, further comprising:
the electronic medical records system adapted to allow the prescriber to generate the prescription by selecting from the list of possible treatments.

9. The electronic prescribing system of claim 1, further comprising:
the electronic medical records system adapted to communicate to the pharmacy the identities of any or all of said medications and their net costs to the patient upon receiving an electronic information request from the pharmacy.

10. The electronic prescribing system of claim 1, further comprising:
the first input selected from the group consisting of: electronic data from a database; an electronic signal from a keyboard; an electronic signal from a mouse; an electronic signal from a computer peripheral device; an electronic signal from a touch screen device; an electronic signal from a scanner; an electronic signal from a card reader.

11. The electronic prescribing system of claim 1, further comprising:
the electronic information request selected from the group consisting of: an electronic signal from a keyboard; an electronic signal from a mouse; an electronic signal from a computer peripheral device; an electronic signal from a touch screen device; an electronic signal from a scanner.

12. The electronic prescribing system of claim 1, further comprising:
the second input selected from the group consisting of: an electronic signal from a keyboard; an electronic signal from a keyboard; an electronic signal from a mouse; an electronic signal from a computer peripheral device; an electronic signal from a touch screen device; an electronic signal from a scanner.

13. The electronic prescribing system of claim 1, further comprising:
the electronic medical records system adapted to communicate to the prescriber the identities of any or all of said medications and their net costs to the patient by means selected from the group consisting of: email; fax; printed document; electronic display.

14. The electronic prescribing system of claim 1, further comprising:
the one or more databases in electronic communication with the electronic medical records system via the Internet.

15. The electronic prescribing system of claim 1, further comprising:
the pharmacy in electronic communication with the electronic medical records system via the Internet.

16. The electronic prescribing system of claim 1, further comprising:
the one or more financial accounts of the patient's in electronic communication with the electronic medical records system via the Internet.

17. A method of electronically prescribing a medication for a patient, comprising the steps of:
at a location of a health care provider for a patient, inputting into an electronic medical records system a first input identifying the patient and a pharmaceutical benefit provider for the patient;
causing the electronic medical records system to electronically access one or more databases and retrieve therefrom and provide to a prescriber at the location of the health care provider any or all of certain information relating specifically to the patient, said information identifying any or all medications for which the pharmaceutical benefit provider provides financial benefits for the patient, said information further identifying the net cost to the patient of each of said medications in view of all financial benefits that the pharmaceutical benefit provider provides to the patient for each of said medications at a current time;
at the location of the health care provider, inputting into the electronic medical records system a second input comprising a prescription for the patient for one or more of said medications; and
causing the electronic medical records system to electronically communicate said prescription to a pharmacy.

18. The method of electronically prescribing a medication for a patient of claim 17, further comprising the steps of:
causing the electronic medical records system to electronically communicate with one or more financial accounts of the patient's; and
causing the electronic medical records system to electronically bill said one or more financial accounts automatically in a predetermined order of preference.

19. The method of electronically prescribing a medication for a patient of claim 17, further comprising the steps of:
inputting a patient diagnosis into the electronic medical records system;
receiving from the electronic medical records system a list of possible treatments for the patient based on the patient diagnosis; and
wherein the step of inputting a second input comprises selecting one or more medications from the list of possible treatments.

20. A method of modifying an electronic prescribing system, the electronic prescribing system comprising: an electronic medical records system comprising one or more processor units, one or more programmable memory units, data storage medium, one or more input ports, one or more output ports, and circuitry connecting to a network; the method comprising the steps of:
reprogramming one or more of the programmable memory units to cause one or more of the processor units to change the content of and redirect from a first destination to a second destination certain electronic communications sent from the electronic medical records system through the network;
wherein the content of said certain electronic communications is changed from a request for non-patient-specific formulary information for a benefit provider to a request for patient-specific benefit information regarding medications for which a pharmaceutical benefit provider provides financial benefits for a specific patient; and
wherein the first destination comprises one or more first databases in electronic communication with the network, the one or more first databases containing first benefit data that is at least primarily non-patient-specific, and the second destination comprises one or more second databases in electronic communication with the network, the one or more second databases containing second benefit data that is at least primarily patient-specific.
